(19) United States
(12) Patent Application Publication
(10) Pub. No.: US 2012/0185319 A1
(43) Pub. Date: Jul. 19, 2012

(54) METHOD FOR DISTRIBUTIONG PROMOTIONAL OFFERS TO CONSUMERS

(76) Inventor: Scott Visger, Brighton, MI (US)

(21) Appl. No.: 13/349,096

(22) Filed: Jan. 12, 2012

Related U.S. Application Data
(60) Provisional application No. 61/432,626, filed on Jan. 14, 2011.

(51) Int. Cl. G06Q 30/02

(52) U.S. Cl. 705/14.26

(57) ABSTRACT

A method for distributing promotional offers, such as coupons, to consumers via a communication network. The method enables consumers to specify their favorite places of business and to receive promotional offers from those businesses. The selections are stored in a computer database and, upon command by the user over the communication network, the server transmits a pattern representative of all of the saved promotional offers by that particular consumer. That pattern may be printed or simply displayed on a personal electronic device, such as a smart phone, at the business in order to utilize or redeem the promotional offer from that business.

### CROSS REFERENCE TO RELATED APPLICATIONS

This application claims priority of U.S. Provisional Patent Application Ser. No. 61/432,626 filed Jan. 14, 2011, which is incorporated herein by reference.

### BACKGROUND OF THE INVENTION

I. Field of the Invention

The present invention relates to a method for distributing promotional offers from businesses to consumers over a communication network, such as the World Wide Web.

II. Description of Related Art

Commercial businesses which sell services and/or goods to consumers have long relied upon advertising to increase their business. Such advertising comes in many different forms.

For example, radio and television advertising is used by many businesses to reach a rather wide range of local consumers. Such radio and television advertising, however, is relatively expensive to purchase.

Print medium, such as newspaper advertising and fliers in the newspaper delivery, is also used by many businesses to promote business. Much of this advertising also includes coupons that can be redeemed by the consumer at the particular place of business. Such coupons not only effectively increase the business traffic at the place of business, but also allow the business owner to gauge the effectiveness of his or her advertising.

One disadvantage of print media advertising and coupons, however, is that it is both difficult and time consuming for the consumer to sort through the print media advertising and the coupons contained therein in order to find the coupons and other promotional offers which are attractive to that consumer. The collection of such coupons and promotional offers from businesses that are of interest to a particular consumer is also time consuming. Furthermore, coupons or other promotional offers that may be of interest to a particular consumer may be inadvertently missed by the consumer. Lastly, collecting, organizing, and redeeming conventional printed coupons is very cumbersome and time consuming.

### SUMMARY OF THE PRESENT INVENTION

The present invention provides a method of distributing promotional information from businesses to a plurality of consumers which overcomes the above mentioned disadvantages of the previously known advertising methods.

In brief, in the method of the present invention, a server is connected to a communication network, such as the World Wide Web, and maintains an advertising computer database which contains promotional information, such as coupons, events, etc. offered by that particular business. Such promotional material may be temporal, i.e. expire after a preselected date, and will frequently change as a function of the desires of the particular business.

The advertising database also contains other information, such as address, telephone number, map, and business hours, for each business. The business may update this information as required.

Consumers are able to communicate with the server through the communication network via their personal computer or other electronic communication device. The consumer, furthermore, is able to not only browse the promotional information on the server, but is also able to narrow the particular search to a particular geographic area or type of business or service through a search engine maintained at the server. By thus limiting the number of promotional offers or other limitations presented to a particular consumer accessing the server, the consumer is able to avoid browsing through promotional offers in areas, geographic or otherwise, that are of no interest to that particular consumer.

Once a particular promotional offer or offers are identified by the consumer, at the consumer's option, the server will download a printable copy of the promotional offer to that particular consumer.

In the preferred embodiment of the invention, consumers are encouraged to register their names and electronic addresses with the server. By doing this, the individual consumer is able to identify favorite businesses or other interests of that particular consumer. Such information is then stored along with the consumer identification by the server in a consumer computer database.

By storing not only the identity of the consumer in the consumer database, but also the preferred businesses and/or other consumer preferences, in the consumer database, the server is able to rapidly identify new or updated promotional information that is of interest to that particular consumer. Such new promotional information is then periodically emailed by the server to the so identified consumer for perusal and possible use by the consumer.

Registration by the consumer with the server further enables the server to maintain a database of stored promotional information which may include stored coupons that have been selected by the consumer. Upon command of the consumer over the communication network, the server downloads the stored promotional information to the consumer. That promotional information and/or coupons may then be printed by the consumer for use at the particular place of business visited by that consumer. Alternatively, the server may download the promotional information stored by a particular consumer to an electronic device, such as a smart phone, which can simply display the promotional information to the business for redemption.

In the preferred embodiment of the invention, access to all of the stored promotional information and/or stored coupons is maintained on the server. The server then provides the particular consumer with a 2D barcode, such as a QR pattern, which provides access to that stored information. Consequentially, a suitably equipped business will simply scan the 2D barcode to redeem any coupons or other promotions that have been saved by the consumer that are relative to that particular business.

The server is also programmed to permit a “friends” option in which two or more consumers may not only have access to, but download, saved coupons and other promotional material from the other consumer. In this fashion, consumers with similar taste in a particular area are able to benefit from the stored coupons of one or more “friend” consumers who are registered users of the server.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a block diagrammatic view illustrating a system for practicing the method of the present invention;

FIG. 2 is a screen shot of the sign-on page display;

FIG. 3 is a screen shot of the home or search page display;

FIG. 4 is a screen shot of the search result page display;

FIG. 5 is a screen shot of an exemplary coupon page display;

FIG. 6 is a screen shot of the saved coupon page display;

FIG. 7 is a screen shot of an exemplary QR pattern;

FIG. 8 is a screen shot of the favorites page display;

FIG. 9 is a screen shot of the first add friend page display;

FIG. 10 is a screen shot of the second add friend page display;

FIG. 11 is a screen shot of the add a business page display;

FIG. 12 is a screen shot of a business user page redeeming a consumer's promotions;

FIG. 13 is a screen shot of a consumer's typical weekly notice with information links;

FIG. 14 is a screen shot of a business user page with tabs to manage overall account;

FIG. 15 is a screen shot of a business user page building a promotion; and

FIG. 16 is a screen shot of a business user page to manage all promotions.

### DETAILED DESCRIPTION OF A PREFERRED EMBODIMENT OF THE PRESENT INVENTION

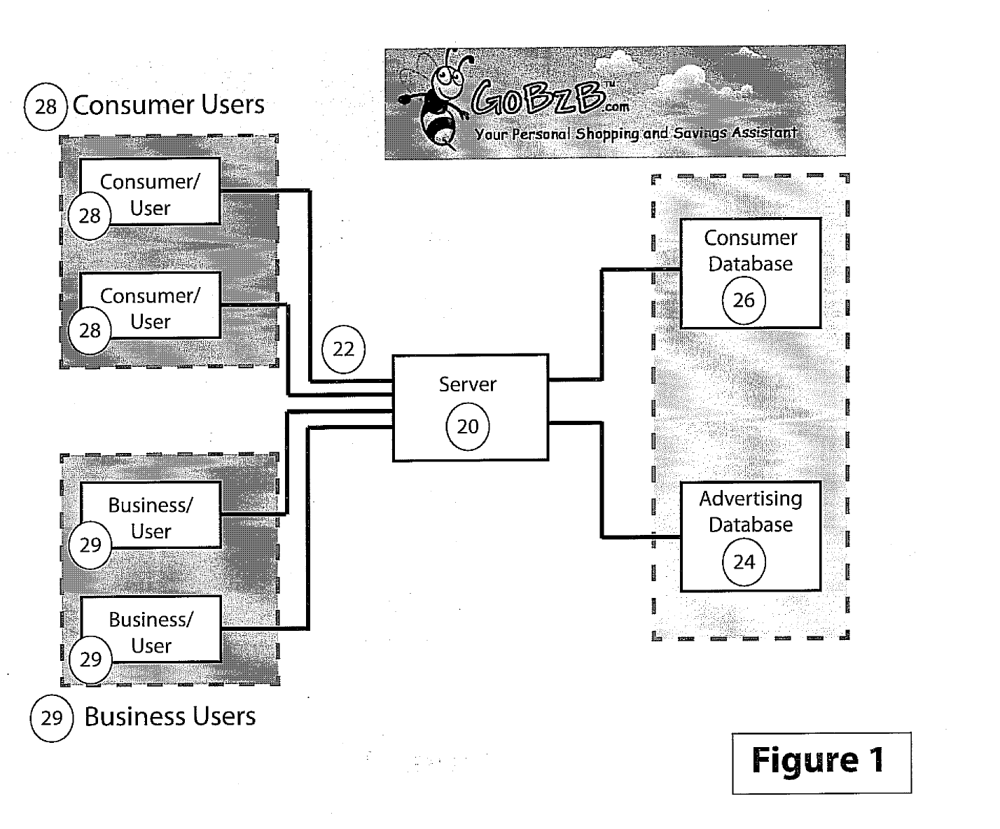

With reference first to FIG. 1, a block diagrammatic view of a system which implements the method of the present invention is illustrated. The system includes a server 20 which has access to a communication network 22, such as the World Wide Web, in any conventional fashion. The server also has access to an advertising database 24 which contains not only the identification of businesses supported by the server 20, but also temporal promotional information, such as coupons, event notices, etc. for that particular business. Each business maintained in the advertising database 24 also includes information as to the type of business, address, map, hours of operation, and other desired business information for that particular business. By thus providing different types of information for the business, the businesses maintained in the advertising database 24 may be easily sorted not only geographically, but also by the particular type of business or specific products or services.

The server 20 also maintains a consumer database 26 of consumers who have registered with the server 20. The consumer database 26 not only includes consumer information, such as the consumer's name, electronic address, as well as other identifying information, but also contains business preferences previously selected by the consumer as well as promotional information previously saved by the consumer. All this information, furthermore, is accessible by the server 20 under software control of a software program and selectively communicated over the communication network 22 to a plurality of consumers 28.

Each consumer 28 has access to equipment to receive information, including images, from the server 20. Consequently, each consumer 28 may have access to a personal computer which not only allows the consumer to provide input information to the server, e.g. selections made by the consumer, but also a display informational screen to allow the consumer to view information communicated from the server 20 and to the consumer 28. Alternatively, however, similar devices, such as a smart phone or computer pad or tablet, may be used by the consumer to not only send information to the server 20 but also to receive information from the server 20 via the communication network 22.

The server 20 also maintains a business user database 29. The business user database contains business user information, such as name and address, but also information relating to business promotions, events, etc. as well as billing information.

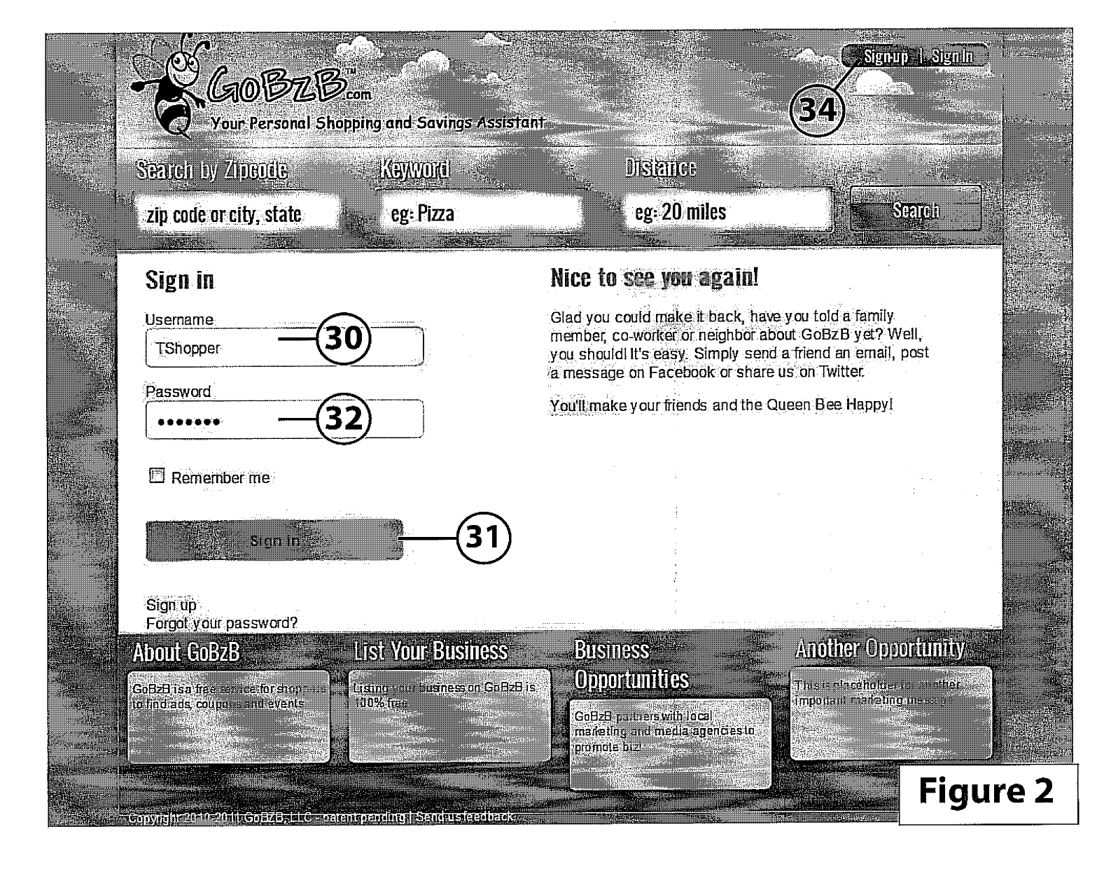

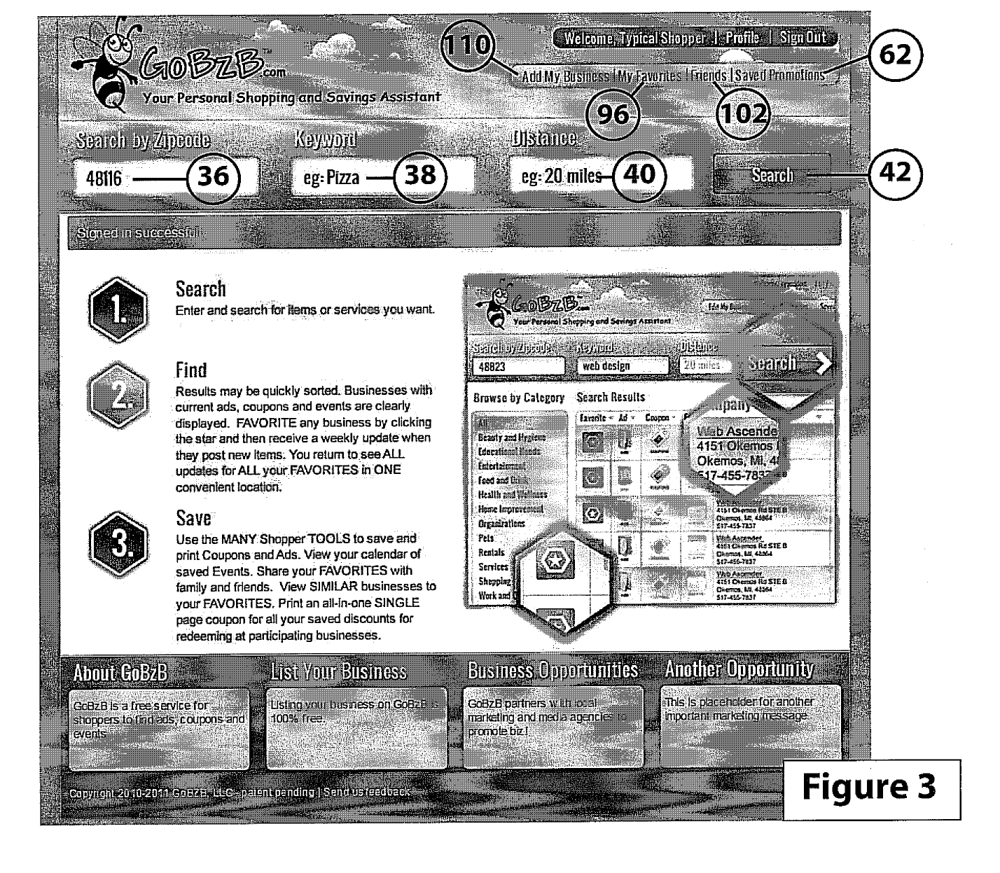

With reference now to FIG. 2, upon access by the consumer 28 to the URL utilized by the server 20, the consumer is presented with the home page shown in FIG. 3. A previously registered consumer then enters the consumer's user name in edit box 30 and password in edit box 32 that the consumer had selected during a prior registration with the URL and selects a sign-in button 31. Conversely, if this is the first visit to this sign-in page, the user may select to register by selecting a sign-up button 34 which allows the consumer to select both a user name as well as a password. Such registration, furthermore, is encouraged since such registration is envisioned to be free. Conversely, any money generated by the system of the present invention will, in all likelihood, be generated by businesses who pay to store their advertising or other promotional information in the advertising database 24 at the server 20.

After the user has signed in, or signed up if it is the first visit to the URL, the user is presented with a search page shown in FIG. 3. In FIG. 3, the user is presented with three search options to identify the desired promotional information currently on file in the advertising database 24 accessible to the server 20. These three search options include a search by geographic area edit field 36, in which the search field may be a zip code, a city, a state, or other geographic identifier.

A second edit field 38 enables the consumer to enter a key word in a key word edit field 38 in order to limit the search for the promotional material. For example, a key word such as “hardware store”, “restaurant”, “clothes store”, “pizza”, etc. may be used to limit the type of promotional material sought.

The last edit field 40 enables the consumer to enter a maximum distance that the consumer is willing to travel for a particular business. By entering the maximum distance that the consumer is willing to travel, the consumer will avoid all of the promotional material from businesses that are outside a geographical acceptable area for that particular consumer.

Once the search criteria have been entered in one or more of the edit fields 36-40, the consumer presses or activates a search button 42 which transmits both the search command as well as the contents of the three edit fields 36-40 to the server 20 via the communication network 22. Upon receipt of this information by the server, the server 20 searches the advertising database 24 to identify all of the promotional information which meets the criteria set by the consumer in the edit fields 36-40. Optionally, the server 20 may also present promotional material that is close to or nearly meets the search criteria identified in the edit fields 36-40.

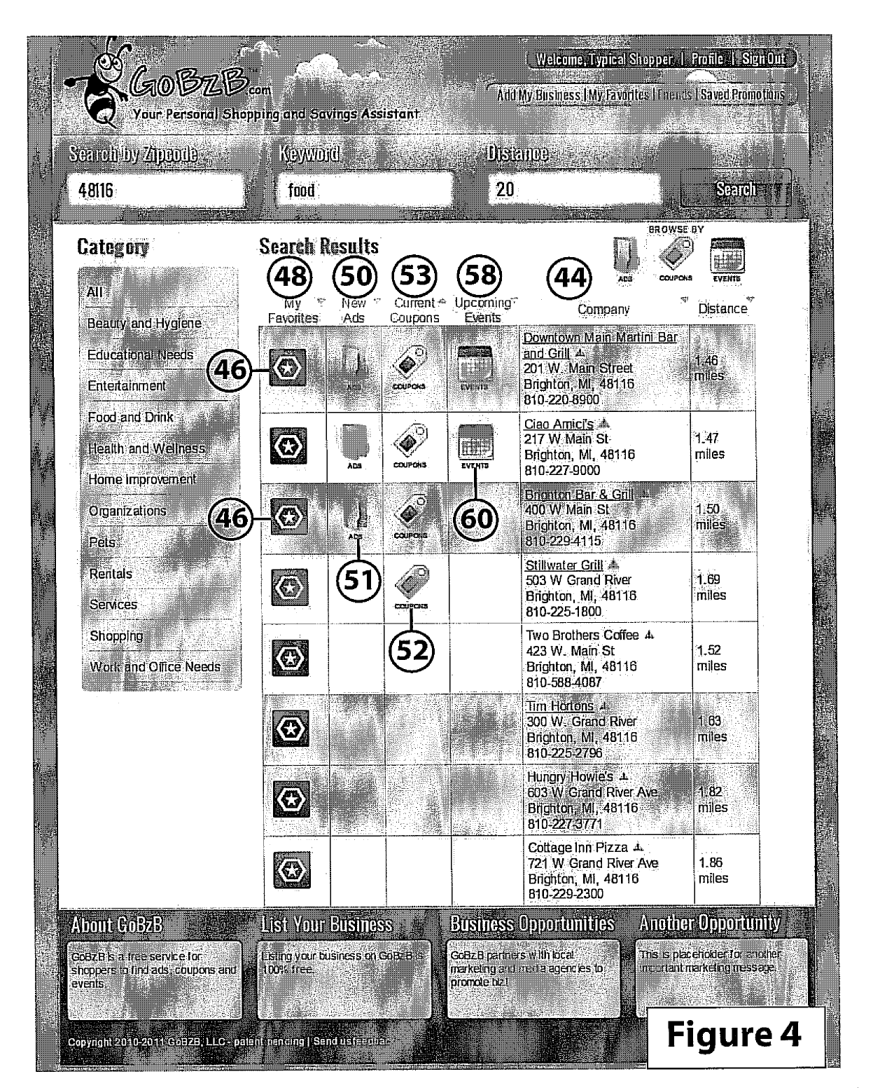

Following the search, the server 20 then communicates a search result page to the consumer 28 requesting the search via the communication network 22. An exemplary search result page is shown in FIG. 4.

With reference then to FIG. 4, the search result page shows a listing of businesses meeting the search criteria in column 44 with information, such as the address and telephone number, of that particular business. The user is also able to denote one or more of the companies in the search column 44 as a favorite business by clicking an icon 46 contained in a separate column 48. One favorite icon 46 is identified with each company in the company column 44. The icons 46 may be alternatively turned on or off by simply clicking the icon.

Still further information contained in the advertising database 24 is displayed on the search result page shown in FIG. 4. For example, a column 50 is provided indicating the number of new ads placed by each business in the business column 44. These new ads may be identified simply as ads placed within a predetermined time period, e.g. within the previous week, or since the last time the consumer had accessed the website.

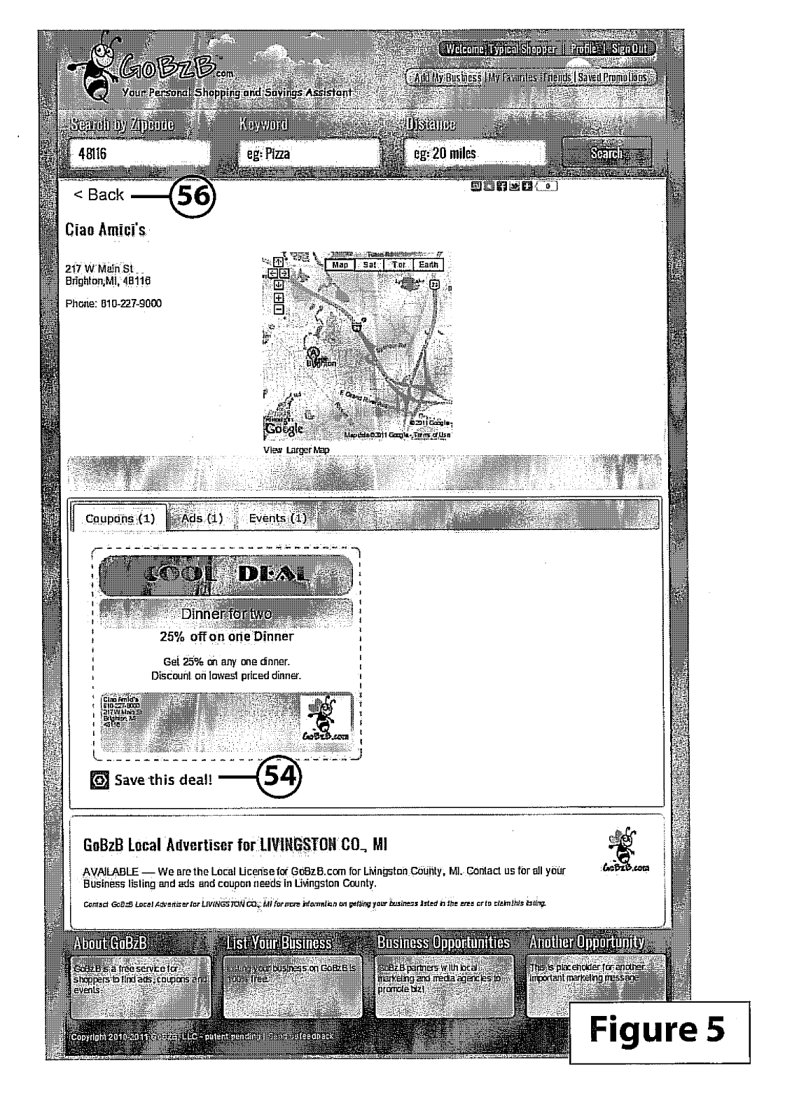

In the event that one or more of the businesses in column 44 has a current coupon, a coupon icon 52 is also displayed in a column 53 so that each coupon icon 52 is associated with the business in the column 44 issuing that coupon. By selecting the coupon icon 52, the coupon from that particular business may then be displayed to the user as shown in FIG. 5. If the consumer is interested in utilizing the particular coupon or other promotional information, the user clicks on the save icon 54 which saves that particular coupon or promotional offer to the consumer database 26 so that that particular coupon or other promotional offer is associated with that particular consumer. The consumer can then return back to the search page by clicking on the back button 56.

The search page also includes an upcoming events column 58 which may contain an event icon 60 for a business having a particular event that it wishes to promote. Clicking on the event icon 60 produces a page analogous to the coupon page (FIG. 5) and allows the consumer to save the event in the consumer database 26 at the server 20 or to the consumer's compatible electronic calendar.

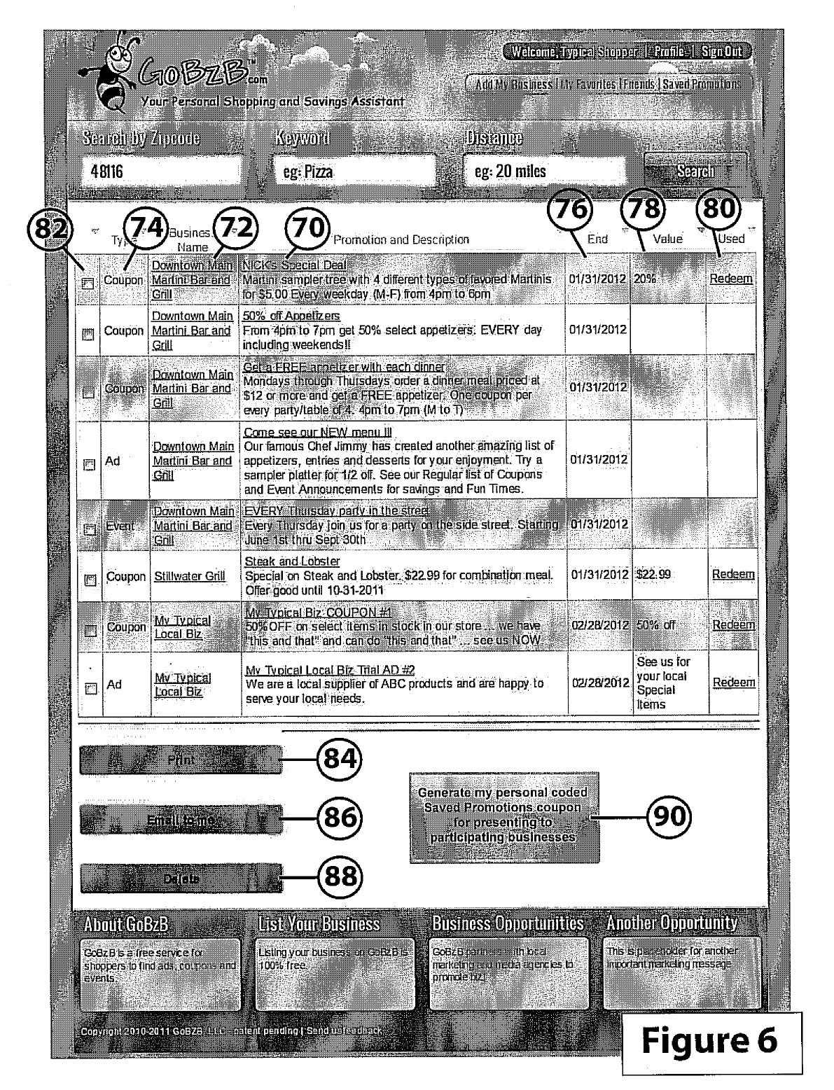

After the consumer is through browsing and saving, as desired, the coupons, the event notices, and other promotional information, the consumer may review his or her saved coupons and event notices by clicking the saved promotions button 62 near the top right of the search page (FIG. 3). Upon receipt of the saved promotion command from the consumer by the server 20, the server 20 searches the consumer database 26 to identify all of the saved promotions for that particular identified consumer and then transmits that information back to the consumer 28 via the communication network 22. An exemplary listing of saved promotions is shown in FIG. 6.

FIG. 6 contains a promotional description column 70 listing all of the coupons previously saved by the consumer while column 72 identifies the business name associated with each coupon, event, or other promotional information. Column 74 identifies the type of promotional information, i.e. a coupon, an event, an advertisement, etc.

The ending date for the particular promotional offer is also displayed in column 76 while the value of the particular promotional offer is displayed in column 78. The status, i.e. whether the promotional offer has been redeemed or is unredeemed, is displayed in column 80.

The saved promotion may be selected by checking the appropriate check boxes in column 82. After selecting the desired promotional information or offer, the consumer may print the offer or offers by selecting a print button 84 at the bottom of the list of saved promotions. Alternatively, the selected saved promotions may be emailed to the consumer by selecting button 86 or deleted by selecting button 88.

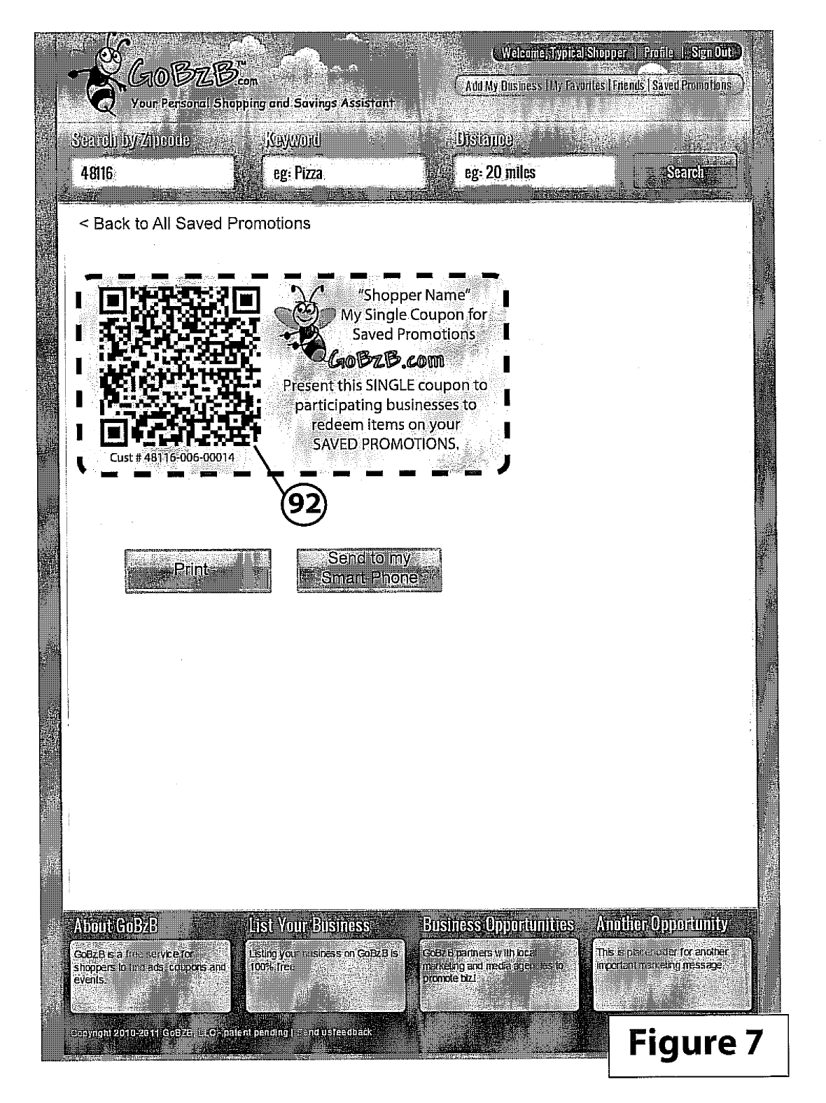

Still referring to FIG. 6, the consumer user may alternately select to generate a coded personal coupon by selecting button 90. Once this button is selected, a coupon is generated with a 2D barcode, such as a QR code pattern, embedded on it 92 as illustrated in FIG. 7 that is specific to this consumer and their saved promotions. This personal coded coupon may then be printed by the consumer or simply displayed on a portable electronic device, such as a smart phone or PDA, to a business having a scanner capable of scanning the pattern 92. Such scanners, and particularly barcode scanners, are becoming increasingly popular in consumer and retail businesses.

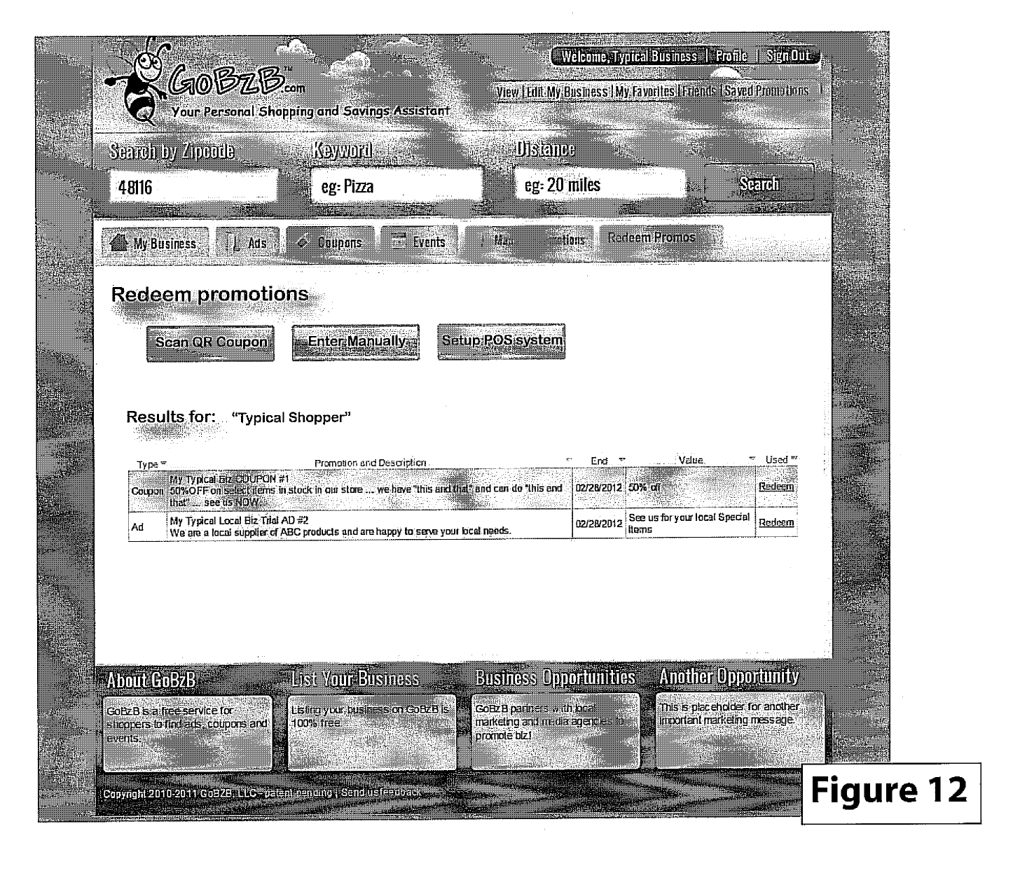

The pattern 92, once displayed and scanned at a business establishment, provides access to the stored promotional information for a particular consumer in the consumer database 26 accessed by the server 20. The scanner at the place of business, in turn, enters the coded data from the pattern 92 into the business's communication network 22 connected computer or other similar network connected device such as PDA or smart phone or point-of-sale system to access that information on the consumer database 26 specific to that consumer and that business. The resulting information is illustrated in FIG. 12, allowing the business to view and redeem the appropriate saved promotion in the consumer's stored data.

By utilizing a single barcode pattern, such as the QR pattern 92, to provide access to all of the stored coupons maintained by a particular consumer, the previously known necessity of physically carrying tens if not hundreds of different coupons is completely avoided. Instead, it is only necessary for the consumer to carry a printed copy of the pattern 92 or a portable electronic device capable of displaying the pattern 92 to the scanner at the place of business where the consumer desires to redeem or utilize the business promotion, such as a coupon.

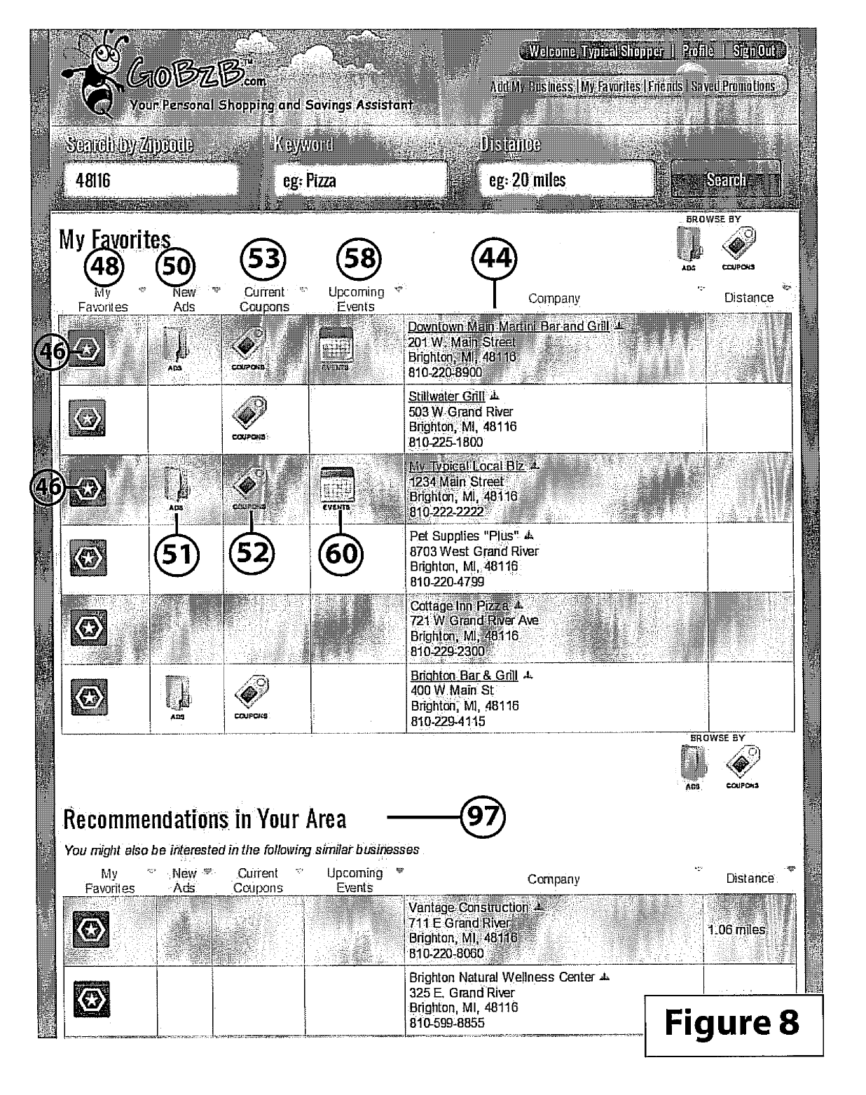

The method of the present invention also provides some additional convenience features which enhance the overall utility of the system. For example, as shown in FIG. 3, the user may select a “my favorites” button 96 which instructs the server under program control to search the consumer database 26 for favorite businesses previously identified and saved by that particular consumer and then transmit that information over the communication network 20 to the consumer 28. An exemplary favorites page is shown in FIG. 8. The listing in FIG. 8 is similar to the listing shown in FIG. 4 and, as such, includes columns identifying not only the businesses, but also new ads, new upcoming events, and current coupons issued by that particular business. The primary difference, however, between the favorites page illustrated in FIG. 8 and the search result page illustrated in FIG. 4 is that the listing in the favorites page in FIG. 8 is limited only to businesses which have been previously identified by that particular consumer as a favorite of the consumer. Conversely, the search page shown in FIG. 4 lists businesses matching the search criteria regardless of whether or not they have been previously identified as favorite businesses of the consumer.

Referring now to FIG. 8, the consumer may browse the new ads and upcoming events of his or her favorite businesses by simply selecting or clicking the respective icons. Furthermore, any business which no longer meets the criteria of a favorite business for a particular consumer may be deleted from the favorite business list by simply clicking on the my favorite icon 46 in the leftmost column. The consumer can also browse businesses similar to their favorites which are displayed in area 97 on FIG. 8 which are generated by the program from comparing the consumer database to the advertising database.

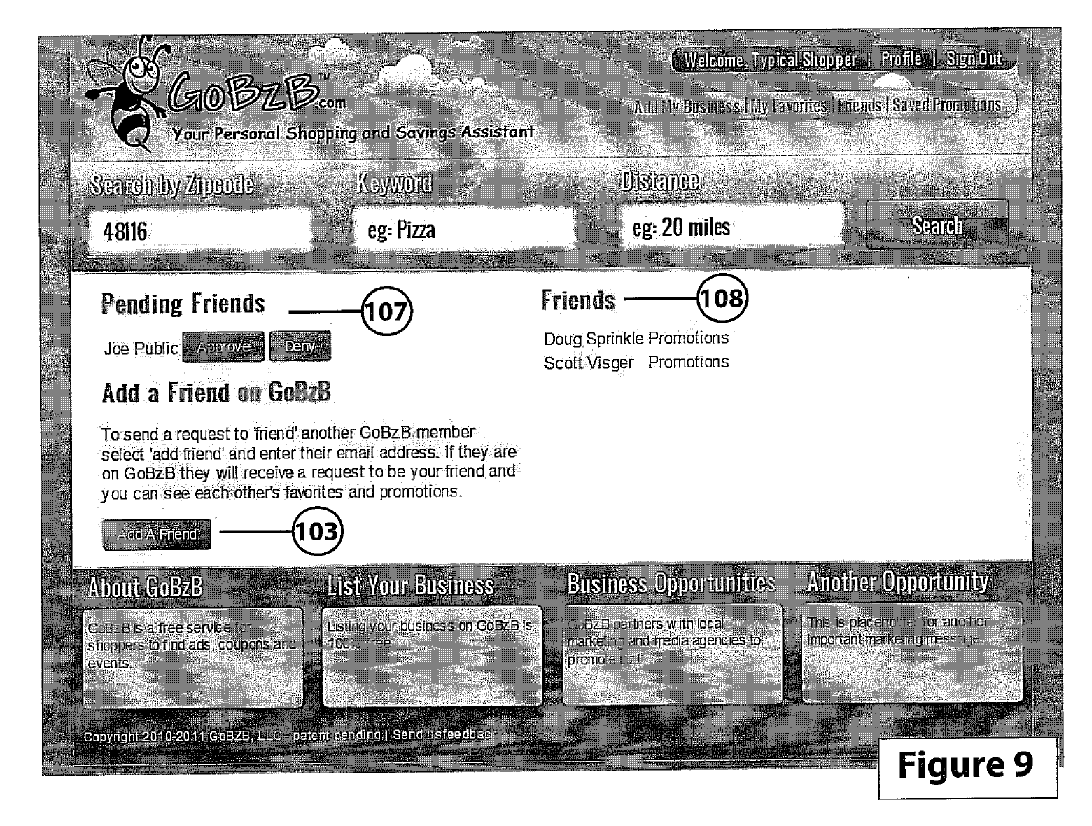

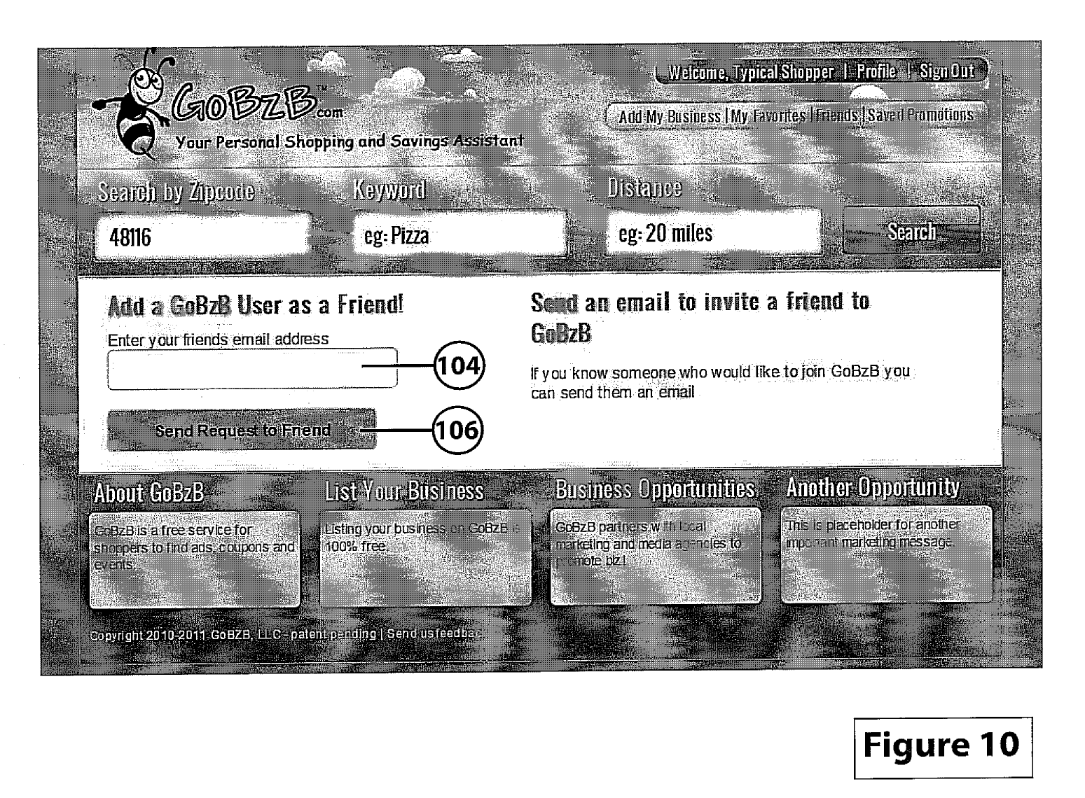

With reference again to FIG. 3, the consumer, after signing in to the website, may select the friends button 102 on the search page whereupon the server 20, in response to that selection, will transmit a friends page as shown in FIG. 9. The friends page allows the consumer to add a friend by selecting the friends button 103. In response to selection of the friends button 103, the server 20 transmits a second friends page shown in FIG. 10 in which the email address of the friend is entered in edit field 104 and sent to the identified friend by selection of a request friend button 106. The friend requested, however, will not actually be added as a friend to the particular consumer until the friend requested has approved or denied the request 107.

Upon a successful request and acceptance of a friend relationship, two or even more consumers who are identified with each other as friends 108 are able to share not only the selected promotional offers, such as coupons, but also the favorite businesses of other friends. Consequently, if two or more friends have similar tastes in virtually any area, such as dining preferences, those consumers can greatly increase their list of preferred businesses through the friends option.

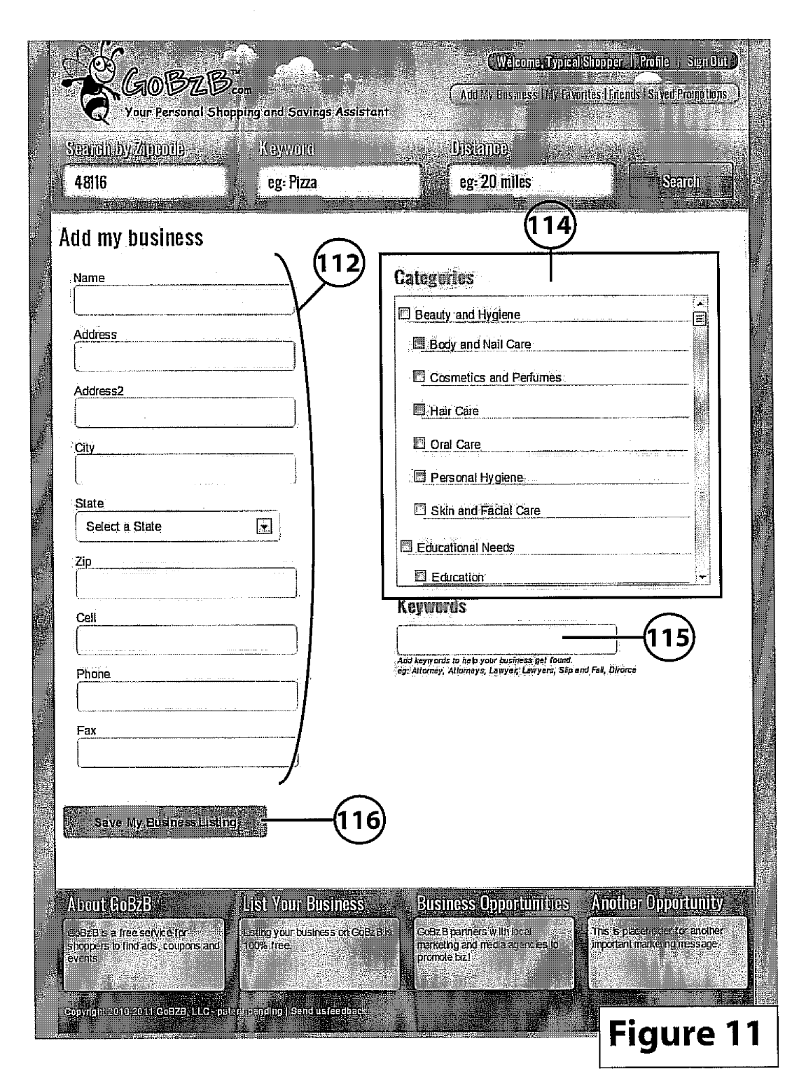

With reference again to FIG. 3, businesses may easily be added to the advertising database 24 by selection of the add business button 110 which then displays the add business display page shown in FIG. 11. The business name and other business information is then entered in the edit fields 112 and one or more categories for the business are selected from a category list 114. Once completed, the information is saved to the advertising database 24 by selecting the save button 116.

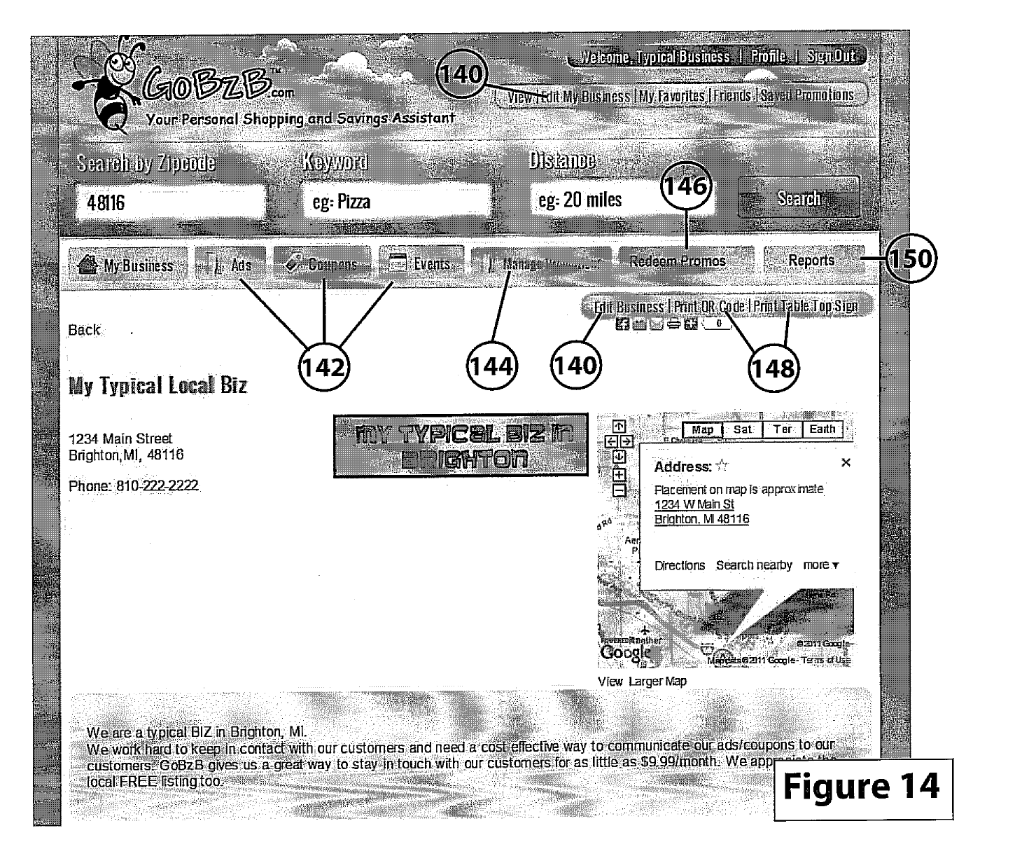

With reference to FIG. 14, FIG. 14 is a screen shot of a business user page with utility features to manage their overall business account. The screen shot in FIG. 14 is reached by selecting the edit my business tab 140 in the header of any signed-in business user's page.

Still referring to FIG. 14, tabs 142 enable the business user to display and edit the ads, coupons, and events for that business. Similarly, tab 144 enables the business to access a summary of all promotions while tab 146 enables the business to redeem promotions presented by the consumer. Tabs 148 enable the business to print flyers and tabletop signs incorporating a QR code pattern specific to that business. Lastly tab 150 generates reports of consumer views and usage of that business's pages and promotions.

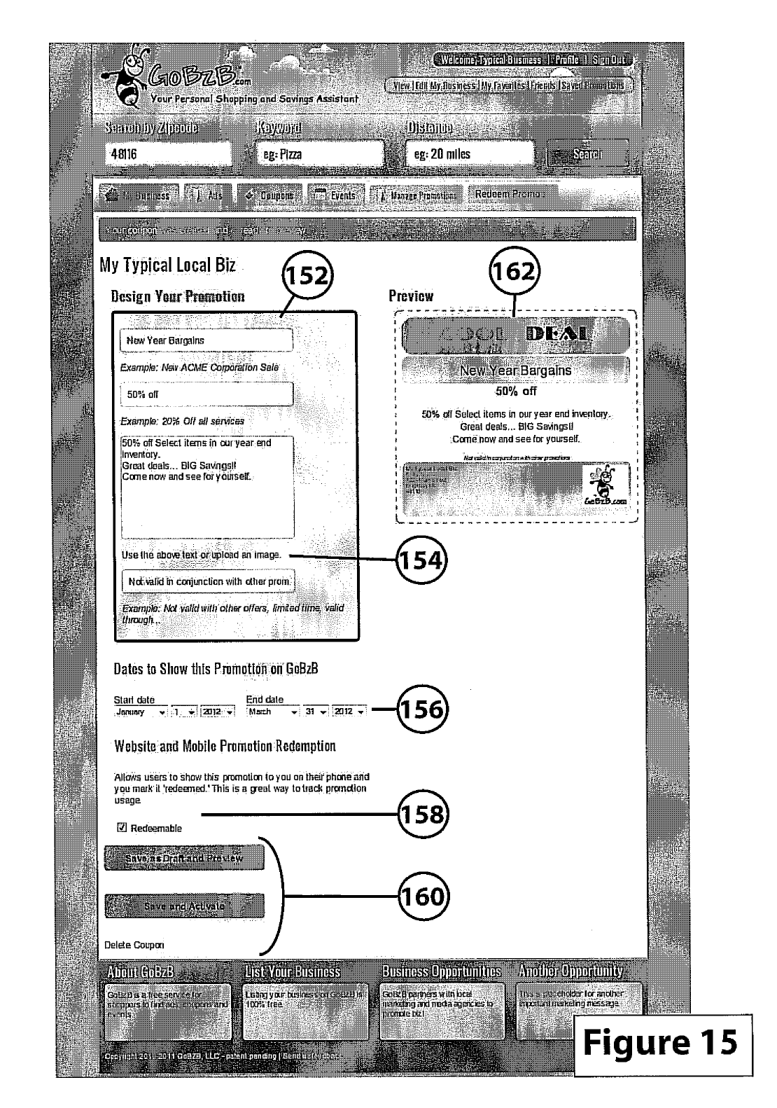

An exemplary screen shot of a business user page for building a promotion is shown in FIG. 15. This page includes a series of data entry boxes 152 for entering the promotion information. Alternately, a business user can upload an image file containing the promotion information by selecting tab 154.

Entry fields 156 enable the business user to enter the start and end dates for the promotion while check box 158 selectably allow the business user to enable the promotion to be redeemable by the business thereby giving them a means of tracking the effectiveness and use of the promotion.

Selectable buttons 160 enable the business user to either save the entered information as a preliminary draft or, alternatively, to save and activate the promotion. The promotion itself, as entered, is displayed in box 162.

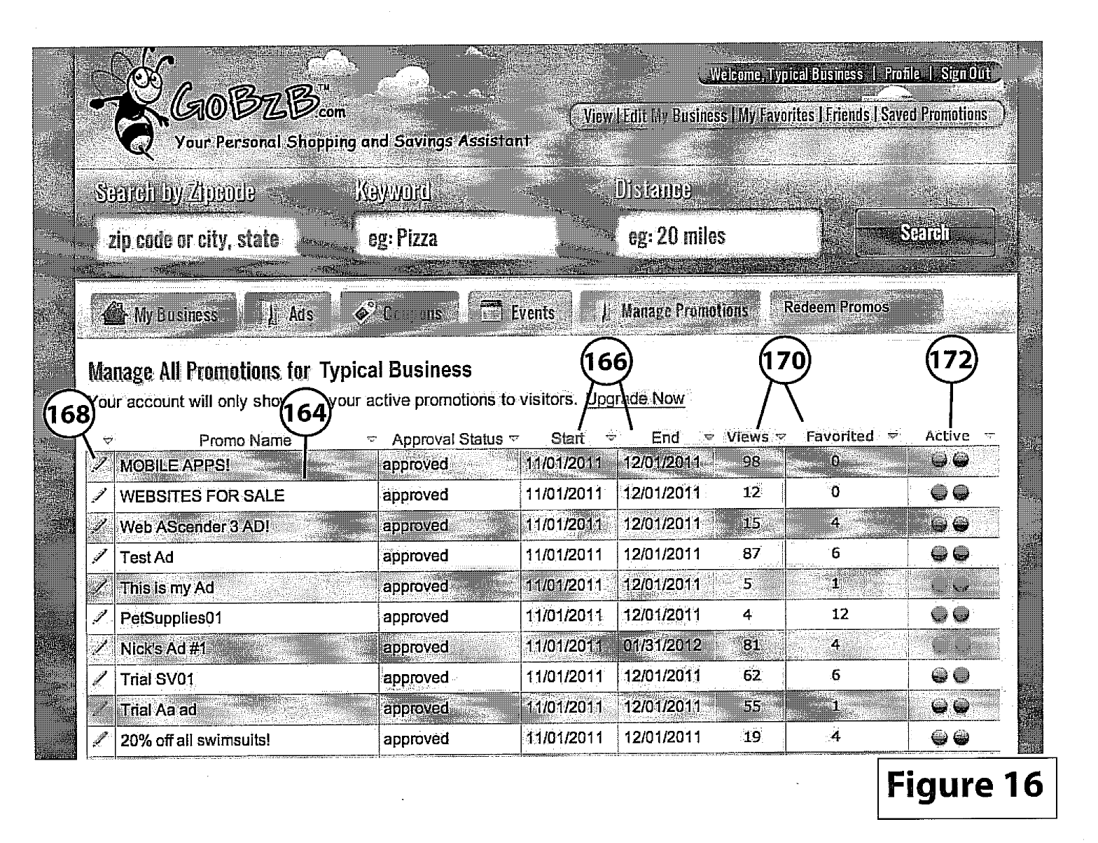

With reference now to FIG. 16, FIG. 16 is a screen shot of a business user page for managing the promotions. It is selected by the button 144 in FIG. 14.

In the displayed promotions in FIG. 16, column 164 displays one or more of the various business promotions for that particular business. Columns 166 display the beginning and end date while columns 170 display the number of times each promotion has been viewed as well as indicated as a favorite business.

Still referring to FIG. 16, column 172 permits the business user to toggle on or off each promotion while a selection field 168 allows the promotions to be individually edited.

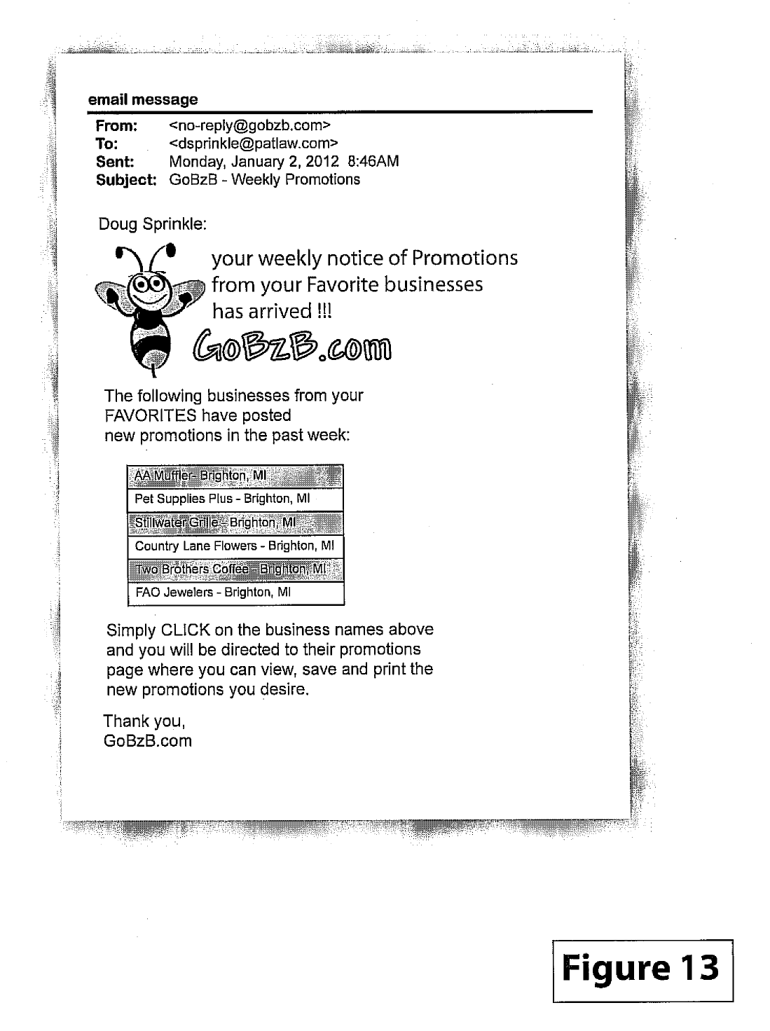

There are still further features of the method of the present invention which enhance its overall utility. For example, once a business enters a new promotional offer, such as a new coupon, the server 20 under program control searches the consumer database 26 for all consumers that have identified that particular business as a favorite business. Once identified, the server 20 generates an electronic communication, such as an email, to those consumers advising those consumers of the new advertising or other promotional information from that particular business. An exemplary such email is shown in FIG. 13.

Similarly, the server 20 under program control periodically deletes coupons and other promotional information from the advertising database 24 once those promotions and advertising information have lapsed. This ensures that only current advertising information is accessible to and presented to the consumers utilizing the overall system.

FIG. 12 also illustrates a business user's page. It includes selectable buttons, typically by a cursor or keyboard, to scan a 2D barcode, such as a QR pattern, to redeem a coupon presented by a consumer at the place of business. Alternatively, a selectable button enables the business to manually enter the customer code if unable to scan the 2D barcode, which code is printed on the coupon. The business user may also set up an interface to its point of sale (POS) system.

From the foregoing, it can be seen that the present invention provides a unique method for distributing advertising, such as promotional offers, to consumers. Having described my invention, however, many modifications thereto will become apparent to those skilled in the art to which it pertains without deviation from the spirit of the invention as defined by the scope of the appended claims.

I claim:

1. A method of distributing promotional offers to consumers comprising the steps of:
storing promotional offers from a plurality of businesses in an advertising computer database accessible by a server,
communicating the promotional offers from the server to consumers via a communication network,
transmitting consumer identification and preference information from the consumer to the server via the communication network and storing said consumer information in a consumer computer database,
selectively communicating the promotional offers to the consumers via the communication network as a function of selections made by the consumer,
enabling consumers to select one or more of the promotional offers and save the selected promotional offers to the consumer computer database,
selectively transmitting a pattern which provides access to the saved promotional offers by an individual consumer in the consumer database, and
thereafter using the pattern to redeem or utilize the promotional offer at one or more businesses making the promotional offer.

2. The method as defined in claim 1 wherein said pattern is a 2D barcode.

3. The method as defined in claim 1 wherein said promotional offers include coupons.

4. The method as defined in claim 1 wherein said consumer information includes user selected favorite businesses.

5. The method as defined in claim 4 and further comprising the step of notifying the consumers of updated promotional offers from said selected favorite businesses.

6. The method as defined in claim 4 and comprising the step of, at the consumer's option, communicating only promotional offers from said selected favorite businesses to the consumer via the communication network.

7. The method as defined in claim 1 and comprising the steps of:
inputting search criteria at the server from the consumer via the communication network,
searching the promotional offer database for promotional offers matching the search criteria, and
communicating the results of the search to the consumer via the communication network.

8. The method as defined in claim 7 and comprising the step of also communicating promotional information which nearly matches the search criteria from the server to the consumer.

9. The method as defined in claim 1 wherein said pattern is printable by the consumer.

10. The method as defined in claim 1 and comprising the step of the server transmitting the pattern to a portable electronic device.

11. The method as defined in claim 10 wherein said portable electronic device is a smart phone.

12. The method as defined in claim 1 and comprising the steps of:
two or more consumers identifying each other as friends to the server,
said server thereafter enabling access to said two or more consumers of each other's stored selected promotional offers.

13. The method as defined in claim 1 wherein said promotional information includes data regarding an event at the business.

14. The method as defined in claim 1 and comprising the step of communicating only consumer selected promotional information from the server to a portable electronic device.
